(19) United States
(12) Patent Application Publication
(10) Pub. No.: US 2013/0021269 A1
(43) Pub. Date: Jan. 24, 2013

(54) Dynamic Control of an Active Input Region of a User Interface

(71) Applicants: Michael P. Johnson, Sunnyvale, CA (US); Thad Eugene Starner, Mountain View, CA (US); Nirmal Patel, Mountain View, CA (US); Steve Lee, San Francisco, CA (US)

(72) Inventors: Michael P. Johnson, Sunnyvale, CA (US); Thad Eugene Starner, Mountain View, CA (US); Nirmal Patel, Mountain View, CA (US); Steve Lee, San Francisco, CA (US)

(73) Assignee: GOOGLE INC., Mountain View, CA (US)

(21) Appl. No.: 13/296,886

(22) Filed: Nov. 15, 2011

Related U.S. Application Data
(60) Provisional application No. 61/509,990, filed on Jul. 20, 2011.

(51) Int. Cl. G06F 3/041

(52) U.S. Cl. 345/173

(57) ABSTRACT

The systems and methods described herein may help to provide for more convenient, efficient, and/or intuitive operation of a user-interface. An example computer-implemented method may involve: (i) providing a user-interface comprising an input region; (ii) receiving data indicating a touch input at the user-interface; (iii) determining an active-input-region setting based on (a) the touch input and (b) an active-input-region parameter; and (iv) defining an active input region on the user-interface based on at least the determined active-input-region setting, wherein the active input region is a portion of the input region.

### RELATED APPLICATIONS

This application claims priority to U.S. Provisional Patent Application Ser. No. 61/509,990, entitled Methods and Systems for Dynamically Controlling an Active Input Region of a User Interface, filed Jul. 20, 2011, which is incorporated by reference.

### BACKGROUND

Unless otherwise indicated herein, the materials described in this section are not prior art to the claims in this application and are not admitted to be prior art by inclusion in this section.

Computing systems such as personal computers, laptop computers, tablet computers, and cellular phones, among many other types of Internet-capable computing systems, are increasingly prevalent in numerous aspects of modern life. As computing systems become progressively more integrated with users' everyday life, the convenience, efficiency, and intuitiveness of the manner in which users interact with the computing systems becomes progressively more important.

A user-interface may include various combinations of hardware and software which enable the user to, among other things, interact with a computing system. One example of a modern user-interface is a “pointing device” that may allow a user to input spatial data into a computing system. The spatial data may be received and processed by the computing system, and may ultimately be used by the computing system as a basis for executing certain computing functions.

One type of pointing device may, generally, be based on a user touching a surface. Examples of common such pointing devices include a touchpad and a touchscreen. Other examples of pointing devices based on a user touching a surface may exist as well. In typical arrangements, the surface is a flat surface that can detect contact with the user's finger. For example, the surface may include electrode-sensors that are arranged to transmit, to the computing system, data that indicates the distance and direction of movement of the finger on the surface.

The computing system may be equipped with a graphical display that may, for example, provide a visual depiction of a graphical pointer that moves in accordance with the movement of the object. The graphical display may also provide a visual depiction of other objects that the user may manipulate, including, for example, a visual depiction of a graphical user-interface. The user may refer to such a graphical user-interface when inputting data. Implementations of a touchpad typically involve a graphical display that is physically remote from the touchpad. However, a touchscreen is typically characterized by a touchpad embedded into a graphical display such that users may interact directly with a visual depiction of the graphical user-interface, and/or other elements displayed on the graphical display, by touching the graphical display itself.

User-interfaces may be arranged to provide various combinations of keys, buttons, and/or, more generally, input regions. Often, user-interfaces will include input regions that are associated with multiple characters and/or computing commands. Typically, users may select various characters and/or various computing commands, by performing various input actions on the user-interface.

User-interfaces may be arranged to provide various combinations of keys, buttons, and/or, more generally, input regions. Typically, input regions are a fixed size and/or are at a static location on a user-interface. Often, user-interfaces will include input regions that are intended for use with a particular computing application and/or a particular graphical display. As such, a user often has to learn how to operate a particular user-interface associated with the particular computing application and/or the particular graphical display.

However, difficulties can arise when a user is viewing a graphical display and concurrently, operating an unfamiliar user-interface, particularly if the user is not directly observing the user-interface input region. It is often considered inconvenient, inefficient, and/or non-intuitive to learn how to operate an unfamiliar user-interface, especially when the user is performing a task which does not permit the user to view the input region. An improvement is therefore desired.

### SUMMARY

The systems and methods described herein may help to provide for more convenient, efficient, and/or intuitive operation of a user-interface. In one aspect, an example system may include a non-transitory computer-readable medium and program instructions stored on the non-transitory computer-readable medium and executable by a processor to: (i) provide a user-interface comprising an input region; (ii) receive data indicating a touch input at the user-interface; (iii) determine an active-input-region setting based on (a) the touch input and (b) an active-input-region parameter; and (iv) define an active input region on the user-interface based on at least the determined active-input-region setting, wherein the active input region is a portion of the input region.

In another aspect, an example system may include: (i) means for providing a user-interface comprising an input region; (ii) means for receiving data indicating a touch input at the user-interface; (iii) means for determining an active-input-region setting based on (a) the touch input and (b) an active-input-region parameter; and (iv) means for defining an active input region on the user-interface based on at least the determined active-input-region setting, wherein the active input region is a portion of the input region.

In another aspect, an example computer-implemented method may involve: (i) providing a user-interface comprising an input region; (ii) receiving data indicating a touch input at the user-interface; (iii) determining an active-input-region setting based on (a) the touch input and (b) an active-input-region parameter; and (iv) defining an active input region on the user-interface based on at least the determined active-input-region setting, wherein the active input region is a portion of the input region.

These as well as other aspects, advantages, and alternatives, will become apparent to those of ordinary skill in the art by reading the following detailed description, with reference where appropriate to the accompanying drawings.

### BRIEF DESCRIPTION OF THE FIGURES

FIG. 1A shows a first view of an example wearable computing system in accordance with an example embodiment.

FIG. 1B shows a second view of the example wearable computing system shown in FIG. 1A.

FIG. 1C shows an example system for receiving, transmitting, and displaying data in accordance with an example embodiment.

FIG. 1D shows an example system for receiving, transmitting, and displaying data in accordance with an example embodiment.

FIG. 2A shows a simplified block diagram of an example computer network infrastructure.

FIG. 2B shows a simplified block diagram depicting components of an example computing system.

FIG. 3 shows a flowchart depicting a first example method for dynamic control of an active input region.

FIG. 4A shows a first simplified depiction of a user-interface with an active input region on the user-interface in accordance with an example embodiment.

FIG. 4B shows a second simplified depiction of a user-interface with an active input region on the user-interface in accordance with an example embodiment.

FIG. 5 shows a simplified depiction of a touch input within an active input region in accordance with an example embodiment.

FIG. 6 shows aspects of a first example active-input-region setting in accordance with an example embodiment.

FIG. 7 shows aspects of a second example active-input-region setting in accordance with an example embodiment.

FIG. 8A shows the control of a first example active-input region in accordance with an example embodiment.

FIG. 8B shows the control of a second example active input region in accordance with an example embodiment.

FIG. 8C shows the control of a third example active input region in accordance with an example embodiment.

FIG. 9 shows the control of a fourth example active input region in accordance with an example embodiment.

FIG. 10A shows aspects of a first example active input region having a live zone and a non-responsive zone in accordance with an example embodiment.

FIG. 10B shows aspects of a second example active input region having a live zone and a non-responsive zone in accordance with an example embodiment

FIG. 11A shows an example heads-up display having an attached user interface, in accordance with an example embodiment.

FIG. 11B shows a third simplified depiction of a user-interface with an active input region on the user-interface in accordance with an example embodiment.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

### 1. Overview

Modern portable computing systems, including wearable computing systems, are commonly limited, at least in one respect, by the manner in which a user performs an input. For example, a common method to perform an input involves the user navigating an input device attached to the computing system. While this approach may be easy to implement by computing system designers/coders, it limits the user to the use of user-interfaces that are attached to the computing system.

The systems and methods described herein may help to provide for more convenient, efficient, and/or intuitive performance of user actions at a user-interface that is not necessarily directly attached to the computing system and without requiring that the user view the user-interface's input region. More specifically, the systems and methods described herein may allow a remote user-interface to be coupled to a computing system having a display and enable a user to operate the remote user-interface in an efficient, convenient, or otherwise intuitive manner, while viewing the display of the computing system and/or some other real-world event or object.

An example embodiment may involve a user-interface having an input region that is capable of dynamically changing location in response to, for example, the location or motion of a user's touch input. Another example embodiment may involve a user-interface having an input region that is capable of dynamically changing size according to (a) an aspect ratio that is associated with a given computing application and/or (b) the size of a user-interface that is commonly (or primarily) used with a given computing system and/or graphical display. Such embodiments may include a cell phone having a user-interface (e.g., a touchpad), where the input region is a portion of the touchpad. Other examples, some of which are discussed herein, are possible as well.

As a non-limiting, contextual example of a situation in which the systems disclosed herein may be implemented, consider a user of a computing system having a graphical display. While, such a computing system may commonly be controlled by a user-interface that is attached to the computing system (e.g., a trackpad of a laptop computer, or a trackpad attached to a heads-up display), it may be desirable for the user to control the computing system with an alternative, convenient, device. Such an alternative device may be, for instance, the user's cell phone. The cell phone and computing system may be communicatively linked. The cell phone may contain a user-interface such as a touchpad, where the touchpad has a portion thereof configured to be an active input region that is capable of receiving user inputs that control the computing system. While observing the graphical display of the computing system, the user may control the computing system from the cell phone without looking down at the cell phone. However, in some cases, it is possible that the user may inadvertently move the user's finger outside of the active input region. Consequently, in accordance with the disclosure herein, the active-input region may be configured to follow the user's finger, upon detecting inputs outside of the active input region, so that, among other benefits, the active input region stays readily accessible to the user. In this sense, the location of the active input region may be dynamically controlled based on the user's input.

### 2. Example System and Device Architecture

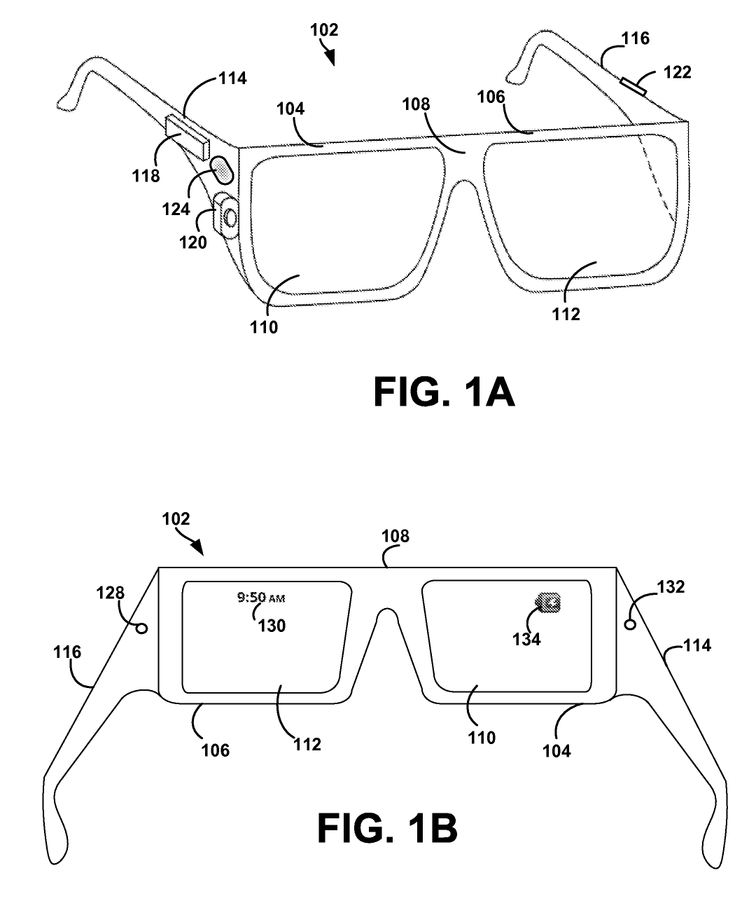

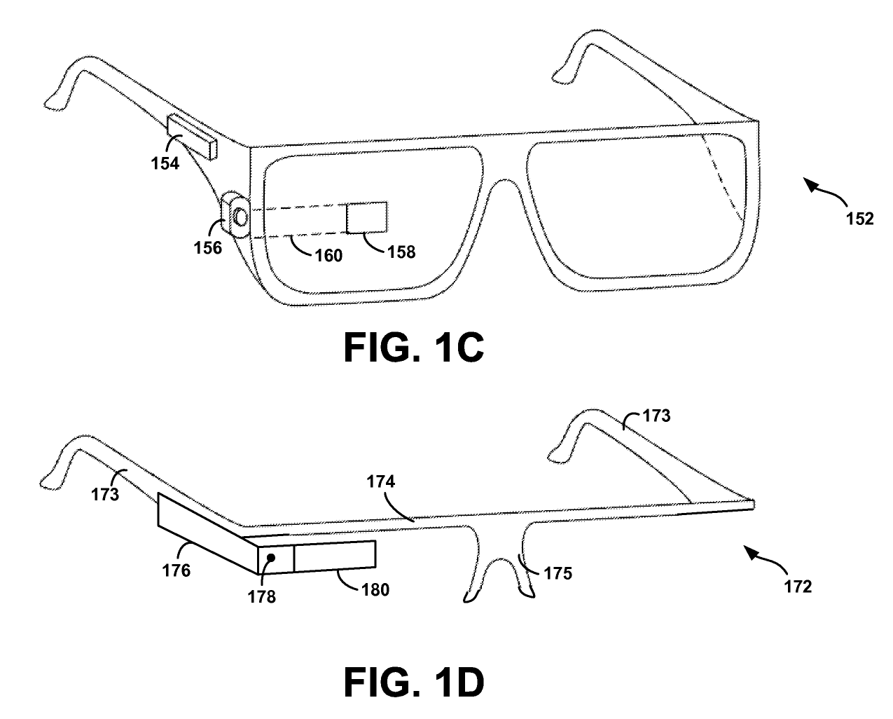

FIG. 1A illustrates a wearable computing system according to an exemplary embodiment. In FIG. 1A, the wearable computing system takes the form of a head-mounted device (HMD) 102 (which may also be referred to as a head-mounted display). It should be understood, however, that exemplary systems and devices may take the form of or be implemented within or in association with other types of devices, without departing from the scope of the invention. As illustrated in FIG. 1A, the head-mounted device 102 comprises frame elements including lens-frames 104, 106 and a center frame support 108, lens elements 110, 112, and extending side-arms 114, 116. The center frame support 108 and the extending side-arms 114, 116 are configured to secure the head-mounted device 102 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the head-mounted device 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind a user's ears to secure the head-mounted device 102 to the user. The extending side-arms 114, 116 may further secure the head-mounted device 102 to the user by extending around a rear portion of the user's head. Additionally or alternatively, for example, the HMD 102 may connect to or be affixed within a head-mounted helmet structure. Other possibilities exist as well.

The HMD 102 may also include an on-board computing system 118, a video camera 120, a sensor 122, and a finger-operable touch pad 124. The on-board computing system 118 is shown to be positioned on the extending side-arm 114 of the head-mounted device 102; however, the on-board computing system 118 may be provided on other parts of the head-mounted device 102 or may be positioned remote from the head-mounted device 102 (e.g., the on-board computing system 118 could be wire- or wirelessly-connected to the head-mounted device 102). The on-board computing system 118 may include a processor and memory, for example. The on-board computing system 118 may be configured to receive and analyze data from the video camera 120 and the finger-operable touch pad 124 (and possibly from other sensory devices, user interfaces, or both) and generate images for output by the lens elements 110 and 112.

The video camera 120 is shown positioned on the extending side-arm 114 of the head-mounted device 102; however, the video camera 120 may be provided on other parts of the head-mounted device 102. The video camera 120 may be configured to capture images at various resolutions or at different frame rates. Many video cameras with a small form-factor, such as those used in cell phones or webcams, for example, may be incorporated into an example of the HMD 102.

Further, although FIG. 1A illustrates one video camera 120, more video cameras may be used, and each may be configured to capture the same view, or to capture different views. For example, the video camera 120 may be forward facing to capture at least a portion of the real-world view perceived by the user. This forward facing image captured by the video camera 120 may then be used to generate an augmented reality where computer generated images appear to interact with the real-world view perceived by the user.

The sensor 122 is shown on the extending side-arm 116 of the head-mounted device 102; however, the sensor 122 may be positioned on other parts of the head-mounted device 102. The sensor 122 may include one or more of a gyroscope or an accelerometer, for example. Other sensing devices may be included within, or in addition to, the sensor 122 or other sensing functions may be performed by the sensor 122.

The finger-operable touch pad 124 is shown on the extending side-arm 114 of the head-mounted device 102. However, the finger-operable touch pad 124 may be positioned on other parts of the head-mounted device 102. Also, more than one finger-operable touch pad may be present on the head-mounted device 102. The finger-operable touch pad 124 may be used by a user to input commands. The finger-operable touch pad 124 may sense at least one of a position and a movement of a finger via capacitive sensing, resistance sensing, or a surface acoustic wave process, among other possibilities. The finger-operable touch pad 124 may be capable of sensing finger movement in a direction parallel or planar to the pad surface, in a direction normal to the pad surface, or both, and may also be capable of sensing a level of pressure applied to the pad surface. The finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad may be operated independently, and may provide a different function.

FIG. 1B illustrates an alternate view of the wearable computing device illustrated in FIG. 1A. As shown in FIG. 1B, the lens elements 110, 112 may act as display elements. The head-mounted device 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

FIG. 1C illustrates another wearable computing system according to an exemplary embodiment, which takes the form of an HMD 152. The HMD 152 may include frame elements and side-arms such as those described with respect to FIGS. 1A and 1B. The HMD 152 may additionally include an on-board computing system 154 and a video camera 156, such as those described with respect to FIGS. 1A and 1B. The video camera 156 is shown mounted on a frame of the HMD 152. However, the video camera 156 may be mounted at other positions as well.

As shown in FIG. 1C, the HMD 152 may include a single display 158 which may be coupled to the device. The display 158 may be formed on one of the lens elements of the HMD 152, such as a lens element described with respect to FIGS. 1A and 1B, and may be configured to overlay computer-generated graphics in the user's view of the physical world. The display 158 is shown to be provided in a center of a lens of the HMD 152, however, the display 158 may be provided in other positions. The display 158 is controllable via the computing system 154 that is coupled to the display 158 via an optical waveguide 160.

FIG. 1D illustrates another wearable computing system according to an exemplary embodiment, which takes the form of an HMD 172. The HMD 172 may include side-arms 173, a center frame support 174, and a bridge portion with nosepiece 175. In the example shown in FIG. 1D, the center frame support 174 connects the side-arms 173. The HMD 172 does not include lens-frames containing lens elements. The HMD 172 may additionally include an on-board computing system 176 and a video camera 178, such as those described with respect to FIGS. 1A and 1B.

The HMD 172 may include a single lens element 180 that may be coupled to one of the side-arms 173 or the center frame support 174. The lens element 180 may include a display such as the display described with reference to FIGS. 1A and 1B, and may be configured to overlay computer-generated graphics upon the user's view of the physical world. In one example, the single lens element 180 may be coupled to the inner side (i.e., the side exposed to a portion of a user's head when worn by the user) of the extending side-arm 173. The single lens element 180 may be positioned in front of or proximate to a user's eye when the HMD 172 is worn by a user. For example, the single lens element 180 may be positioned below the center frame support 174, as shown in FIG. 1D.

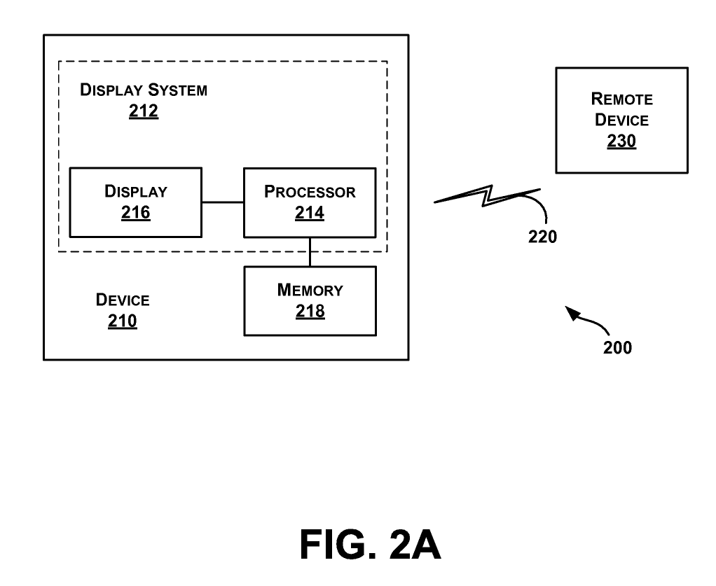

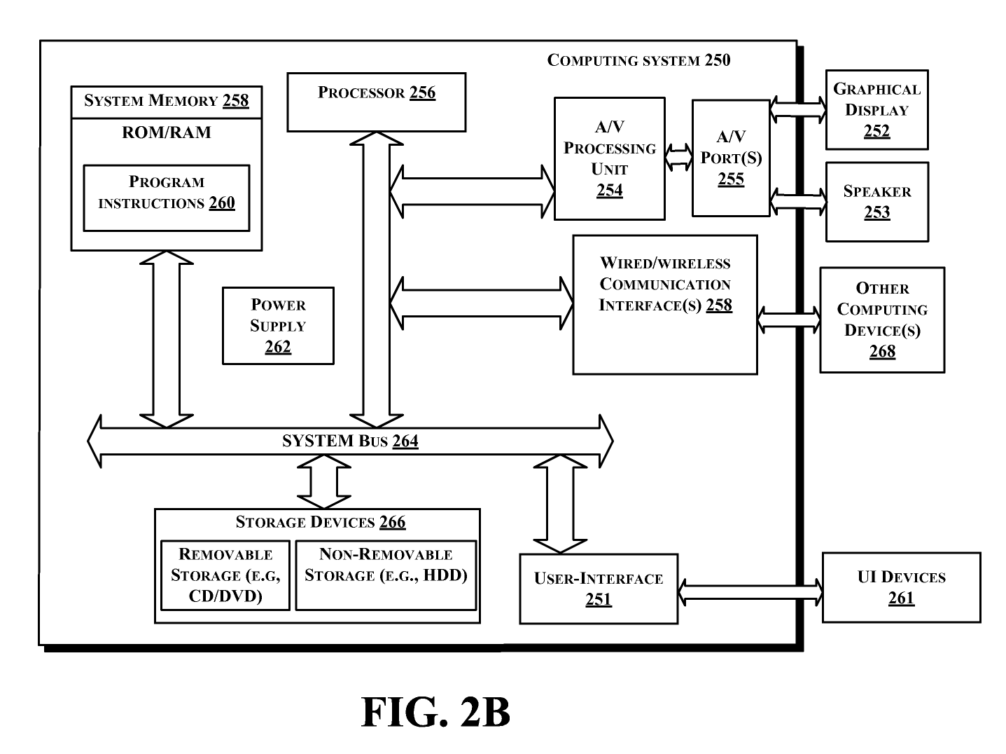

FIG. 2A illustrates a schematic drawing of a computing device according to an exemplary embodiment. In system 200, a device 210 communicates using a communication link 220 (e.g., a wired or wireless connection) to a remote device 230. The device 210 may be any type of device that can receive data and display information corresponding to or associated with the data. For example, the device 210 may be a heads-up display system, such as the head-mounted devices 102, 152, or 172 described with reference to FIGS. 1A-1D.

Thus, the device 210 may include a display system 212 comprising a processor 214 and a display 216. The display 210 may be, for example, an optical see-through display, an optical see-around display, or a video see-through display. The processor 214 may receive data from the remote device 230, and configure the data for display on the display 216. The processor 214 may be any type of processor, such as a micro-processor or a digital signal processor, for example.

The device 210 may further include on-board data storage, such as memory 218 coupled to the processor 214. The memory 218 may store software that can be accessed and executed by the processor 214, for example.

The remote device 230 may be any type of computing device or transmitter including a laptop computer, a mobile telephone, or tablet computing device, etc., that is configured to transmit data to the device 210. The remote device 230 and the device 210 may contain hardware to enable the communication link 220, such as processors, transmitters, receivers, antennas, etc.

In FIG. 2A, the communication link 220 is illustrated as a wireless connection; however, wired connections may also be used. For example, the communication link 220 may be a wired serial bus such as a universal serial bus or a parallel bus. A wired connection may be a proprietary connection as well. The communication link 220 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 230 may be accessible via the Internet and may include a computing cluster associated with a particular web service (e.g., social-networking, photo sharing, address book, etc.).

With reference again to FIGS. 1A and 1B, recall that example system 100 may include, or may otherwise be communicatively coupled to, a computing system such as computing system 118. Such a computing system may take the form of example computing system 250 as shown in FIG. 2B. Additionally, one, or each, of device 202 and remote device 206 may take the form of computing system 250.

Computing system 250 may include at least one processor 256 and system memory 258. In an example embodiment, computing system 250 may include a system bus 264 that communicatively connects processor 256 and system memory 258, as well as other components of computing system 250. Depending on the desired configuration, processor 256 can be any type of processor including, but not limited to, a microprocessor (μP), a microcontroller (μC), a digital signal processor (DSP), or any combination thereof. Furthermore, system memory 258 can be of any type of memory now known or later developed including but not limited to volatile memory (such as RAM), non-volatile memory (such as ROM, flash memory, etc.) or any combination thereof.

An example computing system 250 may include various other components as well. For example, computing system 250 includes an A/V processing unit 254 for controlling graphical display 252 and speaker 253 (via A/V port 255), one or more communication interfaces 258 for connecting to other computing devices 268, and a power supply 262. Graphical display 252 may be arranged to provide a visual depiction of various input regions provided by user-interface 251, such as the depiction provided by user-interface graphical display 210. Note, also, that user-interface 251 may be compatible with one or more additional user-interface devices 261 as well.

Furthermore, computing system 250 may also include one or more data storage devices 266, which can be removable storage devices, non-removable storage devices, or a combination thereof. Examples of removable storage devices and non-removable storage devices include magnetic disk devices such as flexible disk drives and hard-disk drives (HDD), optical disk drives such as compact disk (CD) drives or digital versatile disk (DVD) drives, solid state drives (SSD), and/or any other storage device now known or later developed. Computer storage media can include volatile and nonvolatile, removable and non-removable media implemented in any method or technology for storage of information, such as computer readable instructions, data structures, program modules, or other data. For example, computer storage media may take the form of RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium now known or later developed that can be used to store the desired information and which can be accessed by computing system 250.

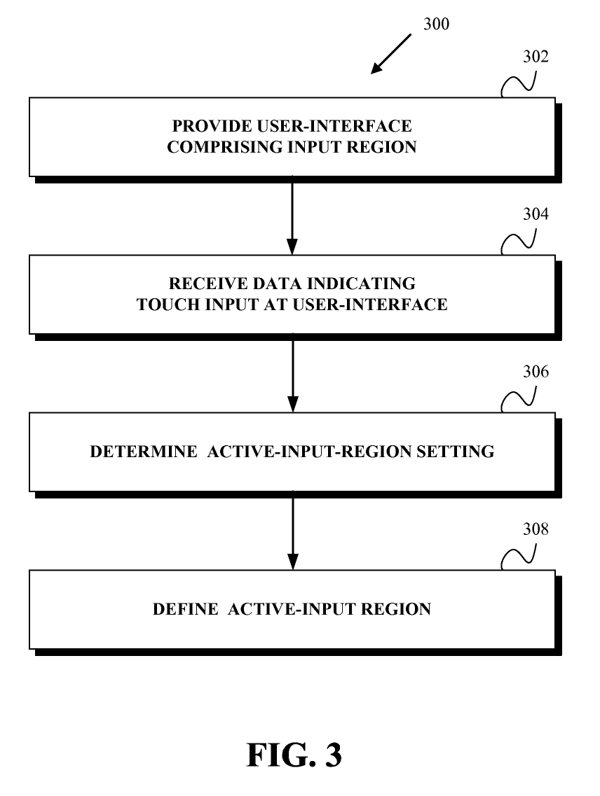

According to an example embodiment, computing system 250 may include program instructions that are stored in system memory 258 (and/or possibly in another data-storage medium) and executable by processor 256 to facilitate the various functions described herein including, but not limited to, those functions described with respect to FIG. 3. Although various components of computing system 250 are shown as distributed components, it should be understood that any of such components may be physically integrated and/or distributed according to the desired configuration of the computing system.

According to an example embodiment, computing system 250 may include program instructions that are stored in system memory 258 (and/or possibly in another data-storage medium) and executable by processor 256 to facilitate the various functions described herein including, but not limited to, those functions described with respect to FIG. 3. Although various components of computing system 250 are shown as distributed components, it should be understood that any of such components may be physically integrated and/or distributed according to the desired configuration of the computing system.

### 3. Example Method

FIG. 3 shows a flowchart depicting a first example method for dynamic control of an active input region. As discussed further below, aspects of example method 300 may be carried out by any suitable computing system, or any suitable components thereof. Example method 300 begins at block 302 with the computing system providing a user-interface including an input region. At block 304, the computing system receives data indicating a touch input at the user-interface. At block 306, the computing system determines an active-input-region setting based on at least (a) the touch input and (b) an active-input-region parameter. At block 308, the computing system defines an active input region on the user-interface based on at least the determined active-input-region setting, where the active input region is a portion of the input region. Each of the blocks shown with respect to FIG. 3 are discussed further below.

a. Provide User-Interface

As noted, at block 302, example method 300 involves providing a user-interface comprising an input region. In an example embodiment, the user-interface may be any user-interface that provides an input region, regardless of, for example, shape, size, or arrangement of the input region. The user-interface may be communicatively coupled to a graphical display that may provide a visual depiction of the input region of the user-interface along with a visual depiction of the position of a pointer relative to the input region. In an example embodiment, the user-interface is part of remote device 206, which is coupled to device 202.

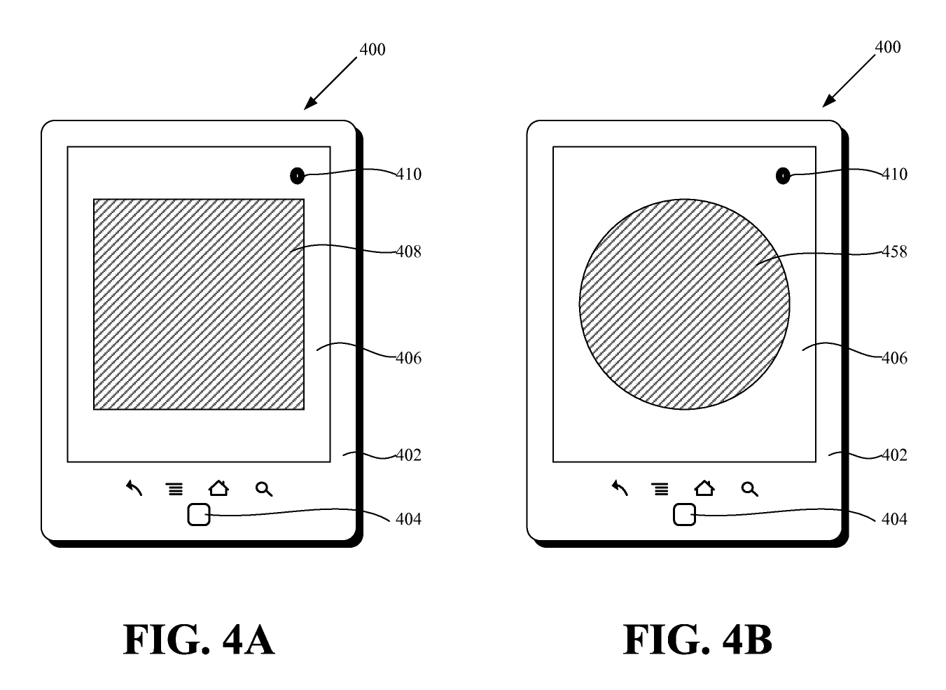

FIG. 4A shows a first simplified depiction of a user-interface with an active input region on the user-interface in accordance with an example embodiment. More particularly, FIG. 4A shows an example remote device 400 that includes a user-interface. It should be understood, however, that example remote device 400 is shown for purposes of example and explanation only, and should not be taken to be limiting.

Example remote device 400 is shown in the form of a cell phone that includes a user-interface. While FIG. 4A depicts cell phone 400 as an example of a remote device, other types of remote devices could additionally or alternatively be used (e.g. a tablet device, among other examples). As illustrated in FIG. 4A, cell phone 400 consists of a rigid frame 402, a plurality of input buttons 404, an input region 406, and an active input region 408. Input region 406 may be a touchscreen, having a touchpad configured to receive touch inputs embedded into a graphical display, and may be arranged to depict active input region 408. Alternatively, input region 406 may be a trackpad, having a touchpad configured to receive touch inputs, but no graphical display.

As noted, the example user-interface of remote device 400 may include plurality of buttons 404 as well as input region 406, although this is not necessary. In another embodiment, for example, the user-interface may include only input region 406 and not plurality of buttons 404. Other embodiments of the user interface are certainly possible as well.

FIG. 4B shows a second simplified depiction of a user-interface with an active input region on the user-interface in accordance with an example embodiment. As shown in FIG. 4B, example active input region 458 may assume any suitable shape. That is, for example, while active-input region 408 as shown is in the general shape of a square, active-input region 458 is in the general shape of a circle. Note that other shapes are certainly possible as well, limited only by the dimensions of input region 406.

b. Receive Touch Input

Returning to FIG. 3, at block 304, example method 300 involves receiving data indicating a touch input at the user-interface. As illustrated in FIGS. 4A and 4B, touch input 410 may occur within input region 406, but outside of active input region 408 and 458, respectively. Generally, touch input 410 involves a user applying pressure from a user's finger to input region 406. Alternatively, the touch input may involve a stylus applying pressure to input region 406. Further, the touch input may involve a simultaneous application of pressure to, along with movement along, input region 406, so as to input an input movement. Other examples of touch inputs may exist as well.

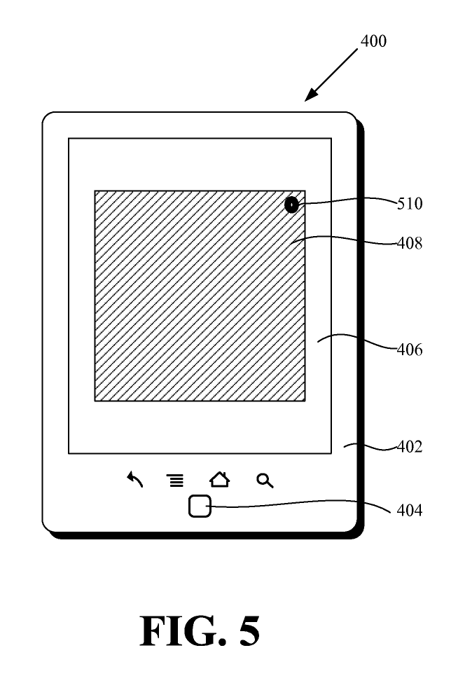

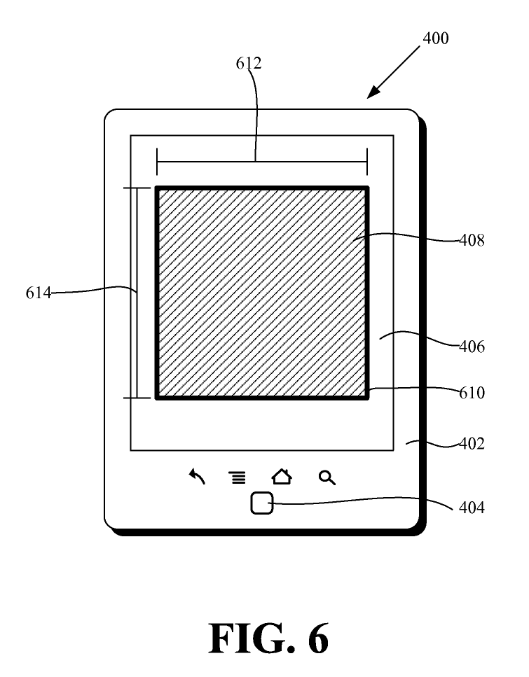

While FIGS. 4A and 4B show touch input 410 occurring outside of active input region 408 and 458, the touch input may also, or alternatively, occur within an active input region. For example, as illustrated in FIG. 5, example touch input 510 may occur within active input region 408. Touch input 510 involves a user applying pressure from a user's finger to active input region 408. Alternatively, the touch input may involve a stylus applying pressure to active input region 408. Further, the touch input may involve a simultaneous application of pressure to, along with movement along, input region 406, so as to input an input movement. Other examples of touch inputs may exist as well.

Thus, a computing device coupled to the user-interface may be configured to receive data indicating an active-input-region touch input within the active input region. Further, a computing device coupled to the user-interface may be configured to receive data indicating an input touch outside of the active-input region. The computing device may be configured to respond to the input touch differently depending on whether the input touch was within or outside of the active input region.

Note that although the touch input corresponding to block 304 is described above as being within input region 406, this is not necessary. For example, the touch input may occur at least one of plurality of input buttons 404.

c. Determining Active-Input-Region Setting and Defining Active Input Region

Returning again to FIG. 3, at block 306, example method 300 involves determining an active-input-region setting based on the touch input and an active-input-region parameter. Such an active-input-region setting may indicate various characteristics of the active input region, and may ultimately be used by a computing device to define an active input region on the user-interface. As will be discussed further below, for example, the active-input-region setting may indicate at least one of (i) an active-input-region width, (ii) an active-input-region height, (iii) an active-input-region location within the input region, (iv) an active-input-region geometry, and (v) an active-input-region aspect ratio.

At block 308, example method 300 involves defining an active input region on the user-interface based on at least the determined active-input-region setting, in which the active input region is a portion of the input region. As discussed below, for purposes of explanation, aspects of the determination of an active-input-region setting in accordance with block 306 and the definition of the active input region in accordance with block 308 are discussed concurrently. It should be understood, however, that blocks 306 and 308 of method 300 may be understood to be carried out by a computing device separately, simultaneously, and/or simultaneously but independently.

FIG. 6 shows aspects of a first example active-input-region setting in accordance with an example embodiment. Generally, the active-input-region setting may define the location and dimensions, among other characteristics, of the active input region within input region 406. With reference to FIG. 6, an example active-input-region setting is shown as including an active-input-region location 610 within input region 406, an active-input-region width 612, and an active-input-region height 614. In another embodiment, the active-input-region setting may involve an active-input-region geometry (e.g, a square, circle, triangle, or other shape) and/or a desired active-input-region aspect ratio (e.g., a desired ratio of width to height). Those of skill in the art will appreciate that other examples of active-input-region settings are certainly possible as well.

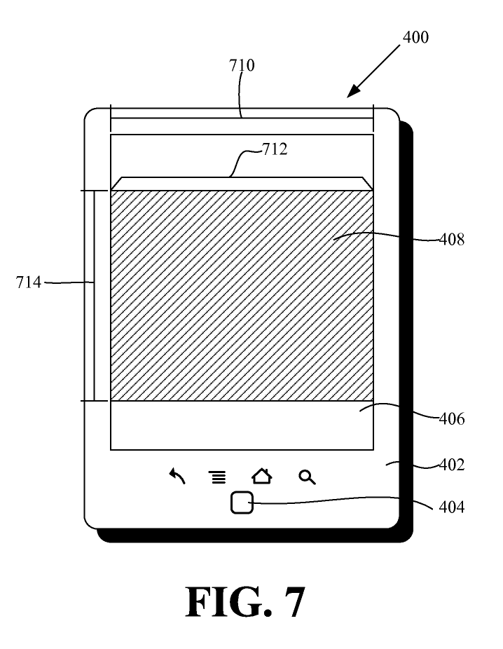

FIG. 7 shows aspects of a second example active-input-region setting in accordance with an example embodiment. As shown in FIG. 7, an example determination of an active-input-region setting may involve first establishing an active-input-region width 712 and then, based on the established active-input-region width 712 and a desired aspect ratio, establishing an active-input-region height. For example, active-input-region width 712 may be initially set equal to the width of a given input region, such as input-region width 710. Then, based on active-input-region width 712 and the desired aspect ratio, active-input-region height 714 may be scaled so that active-input-region width 712 and active-input-region height 714 comply with the desired active-input-region aspect ratio.

Thus, where an active-input-region-setting indicates at least the active-input-region width and the active-input-region aspect ratio, the active-input-region height may be determined based on the active-input-region width and the active-input-region aspect ratio. Alternatively, another example determination of an active-input-region setting may involve first establishing an active-input-region height and then, based on the established active-input-region height and a desired active-input-region aspect ratio, establishing an active-input-region width. The active-input-region height may be initially set equal to the height of a given input region. Then, based on the active-input-region height, the active-input-region width may be scaled so that the active-input-region width and the active-input-region height comply with the desired active-input-region aspect ratio.

Thus, where an active-input-region-setting indicates at least the active-input-region height and the active-input-region aspect ratio, the active-input-region width may be determined based on the active-input-region width and the active-input-region aspect ratio.

The determination of the active-input-region setting may take other forms as well. In some embodiments, a size, shape, and/or location of an active input region within an input region, that is, an active-input-region setting, may be manipulated, modified, and/or changed based on a user's touch input at a user-interface. More particularly, the size, shape, and/or location of the active input region within the input region may be manipulated, modified, and/or changed by the user by a touch input such as a pre-determined input movement, or another type of predetermined contact, made with the input region.

In one embodiment, the size, shape, and/or location of the active input region within the input region may be established and/or changed by the user based on a touch input that outlines a particular shape or geometry within the input region. For example, the user may outline a rough circle on the input region, and the active-input-region setting may correspondingly be determined to be a circle with a diameter approximated by the user-outlined circle.

In some embodiments, an active-input-region aspect ratio may be manipulated, modified, and/or changed by a user of a user-interface. More particularly, the active-input-region aspect ratio may be manipulated by the user through a touch input, such as a pre-determined touch-gesture or a predetermined contact, made with the input region. As one example, the user may touch an edge of an active-input region, and then may “drag” the edge of the active input region such that the aspect ratio of the active input region is manipulated. In another example, the user may touch the active input region with two fingers and make a “pinching” movement, which in turn may manipulate the active input region aspect ratio.

In some embodiments, a size, shape, and/or location of an active input region within an input region may be established and/or changed by a computing device. For example, the size, shape, and/or location of the active input region within the input region may be automatically established and/or changed based on a computer program instruction for example, but not limited to, a computing-application interface setting. As another example, the size, shape, and/or location of the active input region within the input region may be automatically established and/or changed based on both a touch input and a computing-application interface setting. As another example still, the size, shape, and/or location of the active input region may be established and/or changed in response to an event occurring at a communicatively-coupled device, such as a communicatively-coupled device that is running a computer application that operates according to particular interface setting(s).

In some embodiments the communicatively-coupled device may include a graphical display that may receive data from a native input device. For example, the native input device may be a touchpad attached to the graphical display. In another example, the native input device may be a head-mounted device which includes a touchpad and glasses, and a graphical display integrated into one of the lenses of the glasses. The native input device may be able to sense and transmit environmental information provided by various sensors, some of which may include a gyroscope, a thermometer, an accelerometer, and/or a GPS sensor. Other sensors may be possible as well. Other devices made up of a combination of sensors may be used as well including, for example, an eye-tracker or head-orientation tracker. Such information may be used by the computing device to determine an active-input-region setting and/or, ultimately, define the active input region.

In some embodiments, an active-input-region aspect ratio may be established and/or changed automatically by a computing device. For example, the active-input-region aspect ratio may be automatically established and/or changed based on a computer program instruction. As another example, the active-input-region aspect ratio may be automatically established and/or changed based on a touch input and a computer program instruction. As another example still, the active-input-region aspect ratio may be automatically established and/or changed based on an event occurring at a communicatively coupled device.

In some embodiments, at least one of an active-input-region width, an active-input-region height, an active-input-region location within an input region, an active-input-region aspect ratio, and an active-input-region geometry may be set equivalent to a corresponding characteristic of a graphical display device. For example, the active input region may be set equivalent to the size and shape of a window of the graphical display device. Alternatively, the active input region may be set to have an aspect ratio of a window of the graphical display device, while being a scaled (i.e., larger or smaller) size of the actual window of the graphical display device.

In some embodiments, at least one of an active-input-region width, an active-input-region height, an active-input-region location within an input region, an active-input-region aspect ratio, and an active-input-region geometry may be determined based on a touch input, and the remaining active-input-region characteristics may be determined automatically by a computing system. In other embodiments, at least one of the active-input-region width, the active-input-region height, the active-input-region location within the input region, the active-input-region aspect ratio, and the active-input-region geometry may be determined automatically by a computing system, and the remaining active-input-region settings may be determined based on a touch input. Other examples may exist as well.

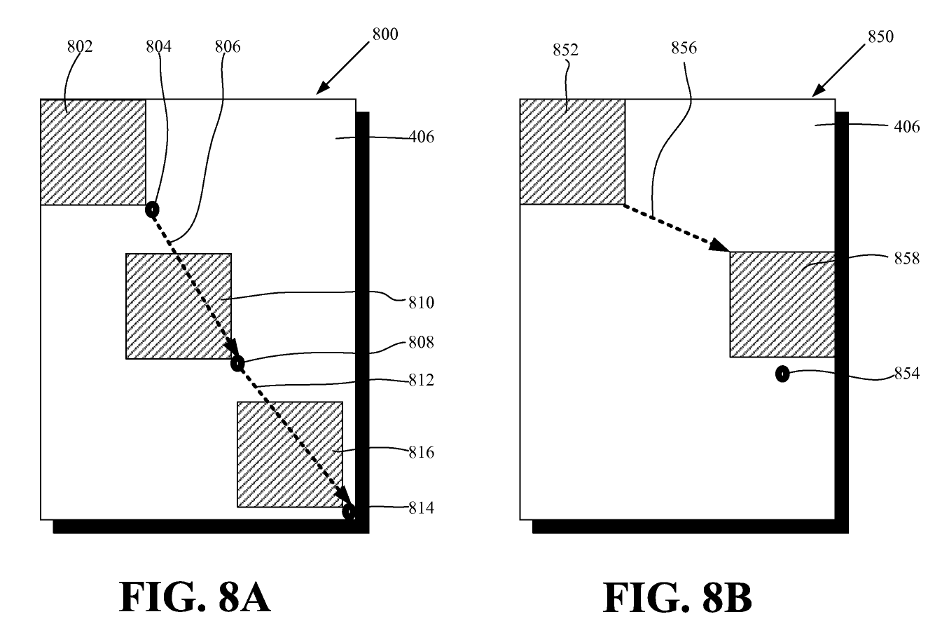

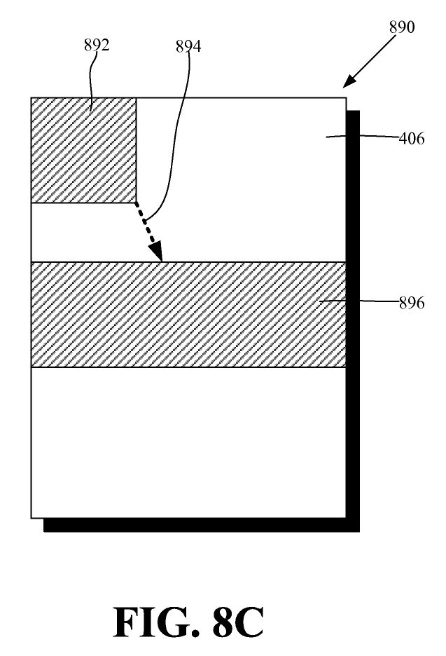

FIG. 8A shows the control of a first example active input region in accordance with an example embodiment. As illustrated in FIG. 8A, example active-input-region setting determination and subsequent active input region definition shown on user-interface 800 involves an active input region following a touch-input movement. Active input region 802 is located within input-region 406. Note that touch input 804 occurs within input region 406 and outside of active input region 802. Touch input 804 is followed by an input movement along touch-input path 806, which ends at touch input 808. Consequently, active input region 802 moves along touch-input path 806 and stops at the location of active-input region 810. The active-input region of input region 406 has thus been changed from active-input region 802 to active input region 810.

Similarly, touch input 808 is followed by an input movement along touch-input path 812, which ends at touch input 814. Consequently, active input region 810 moves along touch-input path 812 and stops at the location of active-input region 814. The active-input region of input region 406 has thus been changed from active input region 810 to active input region 816.

While FIG. 8A depicts the touch-input path to be a straight line, it should be understood that other touch-input paths are also possible. For example, the touch-input path may take the form of a circular trajectory. Other shapes of touch-input paths are certainly possible as well.

FIG. 8B shows the control of a second active input region in accordance with an example embodiment. As illustrated in FIG. 8B, example active input region setting determination and subsequent active input region definition shown on user-interface 850 involves an active input region shifting to an active-input-region location based on a touch input 854. Initially, active input region 852 is located within input region 406 at a first location. At some later time, touch input 854 occurs within input region 406 and outside of active-input region 852. In response to touch input 854, active input region 852 shifts (or relocates) to a second location, i.e., the location of active input location 858. Such a shift may be based on the location of touch input 854 (e.g., oriented above touch input 854), or may be based on a predetermined location (e.g., a location to which the active input region automatically relocates upon receipt of a given touch input). Accordingly, the active input region is subsequently defined to be at active-input-region location 858.

FIG. 8C shows the control of a third active input region in accordance with an example embodiment. As illustrated in FIG. 8C, example active-input-region setting determination and subsequent active input region definition shown on user-interface 890 involves an active input region shifting to a dynamically determined location within an input region and expanding to a dynamically determined active input region size. Initially, active input region 892 is located within input region 406 at a first location. At some later time, an event may occur, for example, at a device communicatively coupled to user-interface 890 and, as a result, data indicating the event may be transmitted from the device to user-interface 890. The active input region of user-interface 890 may be dynamically updated based on the received data. For example, in response to the received data, active input region 892 may be shifted and expanded (as indicated by arrow 894) to the size and location of active input region 896. In other words, in response to the received data, the active input region is defined to be at the location and the size of an active-input-region setting that reflects the size and location of active input region 896. While FIG. 8C illustrates both the movement and the expansion of the active input region in response to data received, alternatively only one of the movement and the expansion may occur in response to the received data. More generally, any type of movement and/or change in size may occur including, but not limited to, a decrease in size or a change in shape of the active input region.

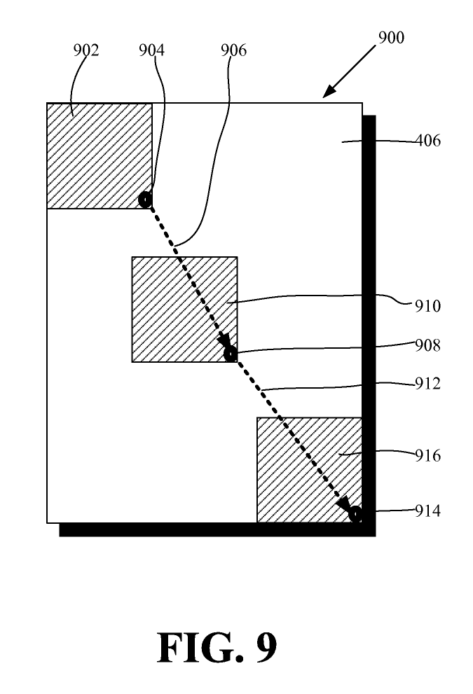

FIG. 9 shows the control of a fourth active input region in accordance with an example embodiment. As illustrated in FIG. 9, example active-input-region setting determination and subsequent active input region definition shown on user interface 900 involves an active input region following a touch-input movement. Active input region 902 is located within input region 406. Touch input 904 occurs within active input region 902. Touch input 904 is followed by an input movement along touch-input path 906, which ends at touch input 908. Consequently, active input region 902 moves along touch-input path 906 and stops at the location of active input region 910. The active input region of input region 406 has thus been changed from active input region 902 to active input region 910. Similar to the above touch-input movement, touch input 908 is followed by an input movement along touch-input path 912, which ends at touch input 914. Consequently, active input region 910 moves along touch-input path 912 and stops at active input region location 914. The active input region of input region 406 has thus been changed from active input region 910 to active input region 916.

While FIG. 9 depicts the touch-input path to be a straight line, it should be understood that other touch-input paths are also possible. For example, the touch-input path may take the form of a circular trajectory. Other shapes of touch-input paths are certainly possible as well.

In some embodiments, at least one touch input within the input region may cause the active input region to shift to a predetermined location, expand to a predetermined size, contract to a predetermined size, transform into a predetermined shape, or otherwise be physically different than the active input region prior to the at least one-touch input. Accordingly, the active input region may be defined based on an active-input-region setting that reflects the transformed active input region.

Similarly, in some embodiments, data received from a communicatively coupled device may cause the active input region to shift to a predetermined location, expand to a predetermined size, contract to a predetermined size, transform into a predetermined shape, or otherwise be physically different than the active input region prior to the received data. Accordingly, the active input region may be defined based on an active-input-region setting that reflects the transformed active input region. For example, a communicatively coupled device may transmit data indicating a particular dimension of the coupled device and consequently, the corresponding active-input-region characteristic may be set equivalent to the received dimension.

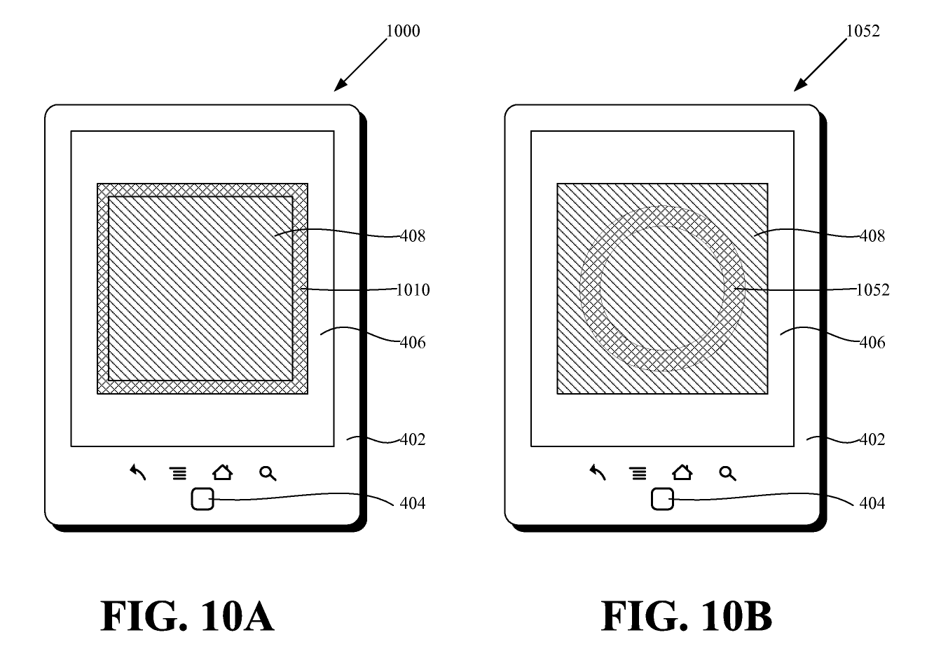

In some embodiments, an additional active input region may be adjacent to, adjoined with, or within the active input region and arranged to provide functionality different from the typical functionality of the active input region. FIG. 10A shows aspects of a first example active input region having a responsive zone and a non-responsive zone in accordance with an example embodiment. As illustrated in FIG. 10A, example additional active input region 1010 surrounds active input region 408. In some embodiments, the additional active input area may be adjacent to or adjoined to only a portion of the active input region perimeter. For instance, as illustrated in FIG. 10B, additional active input area 1052 is placed within active input region 408. In various embodiments, the additional active input area may be oriented horizontally, vertically, or diagonally with respect to the active input region.

In some embodiments, the additional active input area may be configurable by a user input. For example, a length, width, location, geometry, or shape of the additional active input area may be determined by the user input.

In some embodiments, the additional active input area may be automatically configured by a computing system. In some embodiments a length, width, location, geometry, or shape of the additional active input area may be determined by a computer program instruction based on a user input. In some embodiments the length, width, location, geometry, or shape of the additional active input area may be determined by the computer program instruction based on the user input as well as data received indicating an event has occurred or is occurring at a device communicatively coupled with the user interface.

In an embodiment, the additional active input area may be a non-responsive zone. Correspondingly, the original active input area may be a responsive zone. Thus, with reference to FIG. 10A, active input area 408 may be a responsive zone and additional active input area 1010 may be a non-responsive zone. Generally, the computing system may be configured to ignore, or otherwise not react to, user inputs within a non-responsive zone. Such functionality may enable the user-interface to incorporate a sort of “buffer zone” surrounding a responsive zone of an active input region for which user inputs in that zone will not impact the size, location, or other characteristic of the active input region. In other words, user inputs within a non-responsive zone may not impact the active input region. In such a case (i.e., receipt of a user input within a non-responsive zone), determining the active-input-region setting may include determining that the active-input-region setting is equal to an existing active-input-region setting (and as such, the active input region would not necessarily change).

The non-responsive zone may also take the form of a “hysteresis zone” wherein the user input is filtered, or otherwise interpreted differently, from user inputs in the responsive zone. Such a hysteresis zone may include any suitable input filter, a deadzone, or hysteresis requirement potentially involving spatial and/or temporal aspects. As one example, the non-responsive zone may include a hysteresis requirement that an input movement in one direction requires an input movement in another (potentially opposite) direction to leave the non-responsive zone. As another example, user inputs in the non-responsive zone may be passed through a low-pass filter to avoid jittering effects within the non-responsive zone.

On the other hand, user inputs within a responsive zone of an active input region may be used as a basis to take any of those actions described above. As one example, a user input within a responsive zone may be used as a basis to select, and display, a character. As another example, a user input within a responsive zone may be used as a basis to select, and execute, a computing action. Other examples may exist as well.

### 4. Example Embodiment

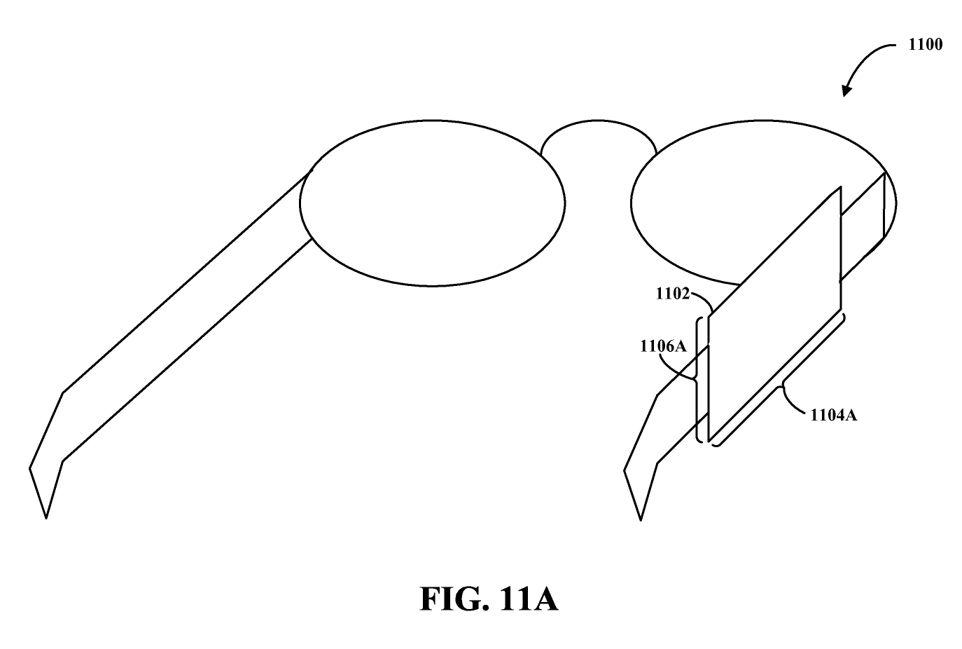

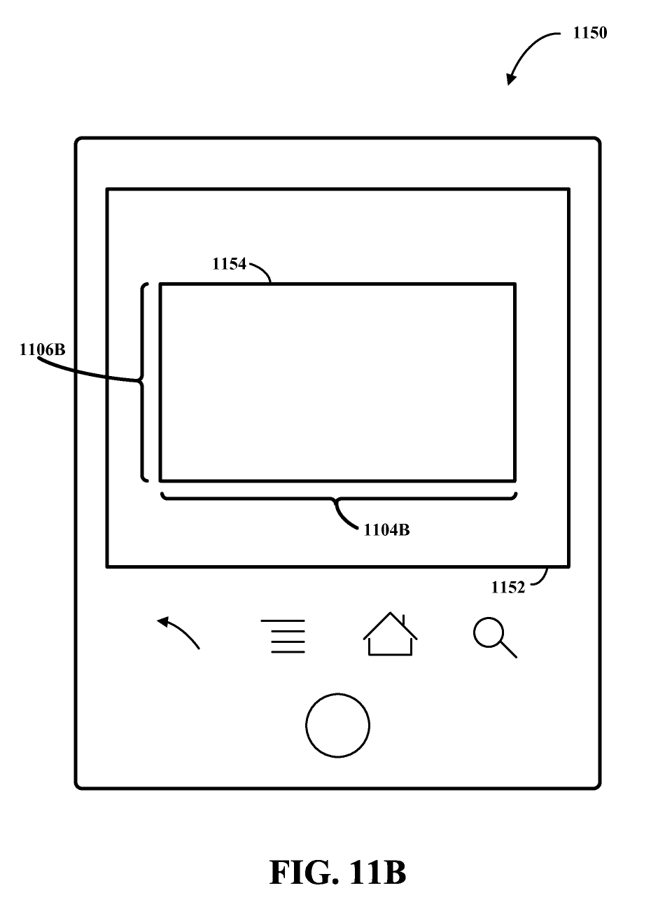

As noted above, in an example embodiment, the shape and/or dimensions of an active input region may be based on the shape and/or dimensions of a user-interface that is attached to a heads-up display. As one specific example of such an embodiment, FIG. 11A shows a heads-up display 1100 having an attached user-interface 1102, and FIG. 11B shows a user-interface 1150 having an input region 1152 including an active input region 1154 that has the same aspect ratio of user-interface 1102.

First, with reference to FIG. 11A, heads-up display 1100 is attached to user-interface 1102. User-interface 1102 may be a trackpad, or other touch-based user-interface, that is commonly used by a wearer of heads-up display 1100 to provide touch inputs. As shown, user-interface 1102 has a width 1104A and a height 1106A.

With reference to FIG. 11B, user-interface 1150 has an input region 1152 including an active input region 1154. User-interface 1150 may be communicatively coupled to heads-up display 1100 shown in FIG. 11A. Further, heads-up display 1100 may be arranged to transmit, and user-interface 1150 may be arranged to receive, information that includes the dimensions of user-interface 1102, including width 1104A and height 1106A. User interface 1150 may thus use such information to define the size of active input region 1154.

As one example, width 1104B of active input region 1154 may be equal to width 1104A and height 1106B of active input region 1154 may be equal to height 1106A. Alternatively, a ratio of width 1104A and height 1106A may be equal to a ratio of width 1104B and height 1106B, such that an aspect ratio of user-interface 1102 is equal to an aspect ratio of active input region 1154.

It should be understood that the examples set forth in FIGS. 11A and 11B are set forth for purposes of example only and should not be taken to be limiting.

In a further aspect, a computing system displaying a user-interface 1150 may be configured to request the dimensions and/or the aspect ratio of the user-interface 1102 of the heads-up display 1100. The computing system may then use the dimensions and/or the aspect ratio to update user-interface 1150 such that an active input region on user-interface 1150 emulates the user-interface 1102 of the heads-up display 1100

### 5. Conclusion

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

Since many modifications, variations, and changes in detail can be made to the described example, it is intended that all matters in the preceding description and shown in the accompanying figures be interpreted as illustrative and not in a limiting sense. Further, it is intended to be understood that the following claims further describe aspects of the present description.

1. A system comprising:
a non-transitory computer readable medium; and
program instructions stored on the non-transitory computer readable medium and executable by at least one processor to cause a computing device to:
provide a user-interface comprising an input region;
receive data indicating a touch input at the user-interface;
determine an active-input-region setting based on (a) the touch input and (b) an active-input-region parameter; and
define an active input region on the user-interface based on at least the determined active-input-region setting, wherein the active input region is a portion of the input region.

2. The system of claim 1, further comprising program instructions stored on the non-transitory computer readable medium and executable by at least one processor to cause a computing device to:
receive data indicating an active-input-region touch input at the active input region.

3. The system of claim 1, wherein the active-input-region setting indicates at least one of (i) an active-input-region width, (ii) an active-input-region height, (iii) an active-input-region location in the input region, (iv) an active-input-region geometry, and (v) an active-input-region aspect ratio.

4. The system of claim 3, wherein the active-input-region-setting indicates at least the active-input-region width and the active-input-region aspect ratio, wherein the determination of active-input-region width is based on an input-region width, the system further comprising program instructions stored on the non-transitory computer readable medium and executable by at least one processor to cause a computing device to:
determine the active-input-region height based on the active-input-region width and the active-input-region aspect ratio.

5. The system of claim 4, wherein the active-input-region setting indicates at least the active-input-region location in the input region, the system further comprising program instructions stored on the non-transitory computer readable medium and executable by at least one processor to cause a computing device to:
determine the active-input-region location based on the touch input.

6. The system of claim 3, wherein the active-input-region-setting indicates at least the active-input-region height and the active-input-region aspect ratio, wherein the determination of active-input-region width is based on an input-region height, the system further comprising program instructions stored on the non-transitory computer readable medium and executable by at least one processor to cause a computing device to:
determine the active-input-region width based on the active-input-region height and the active-input-region aspect ratio.

7. The system of claim 6, wherein the active-input-region setting indicates at least the active-input-region location in the input region, the system further comprising program instructions stored on the non-transitory computer readable medium and executable by at least one processor to cause a computing device to:
determine the active-input-region location based on the touch input.

8. The system of claim 1, wherein the determination of the active-input-region setting is further based on at least one of (i) a touch-input path of a touch-input movement, (ii) a predetermined active-input-region setting, and (iii) a computing-application interface setting.

9. The system of claim 1, wherein, before defining the active input region, the active input region has a first location within the input region, and wherein the active-input-region setting indicates the active-input-region location in the input region, wherein the indicated active-input-region location is a second location within the input region, the system further comprising program instructions stored on the non-transitory computer readable medium and executable by at least one processor to cause a computing device to:
in response to defining the active input region, cause the active input region to move along a touch-input path of a touch-input movement from the first active-input-region location to the second active-input-region location.

10. The system of claim 1, wherein the system further comprises a communication interface configured to communicate with a head-mounted display via a communication network, wherein the active input region is an emulation of a touch-input interface on the head-mounted display.

11. The system of claim 10, wherein the touch-input interface is attached to head-mounted display such that when the head-mounted display is worn, the touch-input interface is located to a side of a wearer's head.

12. The system of claim 10, wherein the active-input-region parameter indicates a dimension of the touch-input interface on the head-mounted display.

13. The system of claim 12, wherein defining the active input region comprises setting a dimension of the active input region equal to the dimension of the touch-input interface on the head-mounted display.

14. The system of claim 1, further comprising program instructions stored on the non-transitory computer readable medium and executable by at least one processor to cause a computing device to:
determine the active-input-region parameter based on at least one of (i) a user-interface input, (ii) a computing-application event, (iii) a computing-application context, and (iv) an environmental context.

15. The system of claim 1, wherein the user interface is communicatively coupled to a graphical-display device comprising a graphical display, and wherein the graphical-display device is configured to receive data from at least one of:
(i) a touch-based interface that is integrated with the graphical display;
(ii) a head-mounted device comprising at least one lens element, wherein the graphical display is integrated into the at least one lens element, and a touch-based interface attached to the head-mounted device;
(iii) a gyroscope;
(iv) a thermometer;
(v) an accelerometer; and
(vi) a global-positioning system sensor.

16. The system of claim 1, wherein the active input region comprises a responsive zone and a non-responsive zone, and wherein the system further comprising program instructions stored on the non-transitory computer readable medium and executable by at least on processor to cause the computing device to:
after defining the active input region, receive data indicating a touch input within the defined active input region; and
determine whether the touch input within the defined active input region was within either one of the responsive zone or the non-responsive zone.

17. The system of claim 16, wherein the touch input within the defined active input region was within the responsive zone, further comprising program instructions stored on the non-transitory computer readable medium and executable by at least one processor to cause a computing device to:
execute a computing action based on the touch input.

18. The system of claim 16, wherein the touch input within the defined active input region was within the non-responsive zone, and wherein determining the active-input-region setting comprises determining that the active-input-region setting is equal to an existing active-input-region setting.

19. The system of claim 16, wherein the active-input-region parameter indicates a non-responsive-zone dimension.

20. The system of claim 1, wherein the computing device is one of a mobile telephonic device and a tablet device.

21. A computer-implemented method comprising:
providing a user-interface comprising an input region;
receiving data indicating a touch input at the user-interface;
determining an active-input-region setting based on at least (a) the touch input and (b) an active-input-region parameter; and
defining an active input region on the user-interface based on at least the determined active-input-region setting, wherein the active input region is a portion of the input region.

22. The method of claim 21, further comprising:
receiving data indicating an active-input-region touch input at the active input region.

23. The method of claim 21, wherein the active-input-region setting indicates at least one of (i) an active-input-region width, (ii) an active-input-region height, (iii) an active-input-region location in the input region, (iv) an active-input-region geometry, and (v) an active-input-region aspect ratio.

24. The method of claim 21, wherein the determination of the active-input-region setting is further based on at least one of (i) a touch-input path of a touch-input movement, (ii) a predetermined active-input-region setting, and (iii) a computing-application interface setting.

25. The method of claim 21, wherein, before defining the active input region, the active input region has a first location within the input region, and wherein the active-input-region setting indicates the active-input-region location in the input region, wherein the indicated active-input-region location is a second location within the input region, the method further comprising:
in response to defining the active input region, causing the active input region to move along a touch-input path of a touch-input movement from the first active-input-region location to the second active-input-region location.

26. The method of claim 21, wherein the user interface further comprises a communication interface configured to communicate with a head-mounted display via a communication network, wherein the active input region is an emulation of a touch-input interface on the head-mounted display.

27. The method of claim 21, further comprising:
determining the active-input-region parameter based on at least one of (i) a user-interface input, (ii) a computing-application event, (iii) a computing-application context, and (iv) an environmental context.

28. The method of claim 21, wherein the user interface is communicatively coupled to a graphical-display device comprising a graphical display, and wherein the graphical-display device is configured to receive data from at least one of:
(i) a touch-based interface that is integrated with the graphical display;
(ii) a head-mounted device comprising at least one lens element, wherein the graphical display is integrated into the at least one lens element, and a touch-based interface attached to the head-mounted device;
(iii) a gyroscope;
(iv) a thermometer;
(v) an accelerometer; and
(vi) a global-positioning system sensor.

29. The method of claim 21, wherein the active input region comprises a responsive zone and a non-responsive zone, the method further comprising:
after defining the active input region, receiving data indicating a touch input within the defined active input region; and
determining whether the touch input within the defined active input region was within either one of the responsive zone or the non-responsive zone.

30. A non-transitory computer readable medium having instructions stored thereon, the instructions comprising:
instructions for providing a user-interface comprising an input region;
instructions for receiving data indicating a touch input at the user-interface;
instructions for determining an active-input-region setting based on at least (a) the touch input and (b) an active-input-region parameter; and
instructions for defining an active input region on the user-interface based on at least the determined active-input-region setting, wherein the active input region is a portion of the input region.

31. The non-transitory computer readable medium of claim 30, the instructions further comprising:
instructions for receiving data indicating an active-input-region touch input at the active input region.

32. The non-transitory computer readable medium of claim 30, wherein the active-input-region setting indicates at least one of (i) an active-input-region width, (ii) an active-input-region height, (iii) an active-input-region location in the input region, (iv) an active-input-region geometry, and (v) an active-input-region aspect ratio.

33. The non-transitory computer readable medium of claim 30, wherein the determination of the active-input-region setting is further based on at least one of (i) a touch-input path of a touch-input movement, (ii) a predetermined active-input-region setting, and (iii) a computing-application interface setting.

34. The non-transitory computer readable medium of claim 30, wherein, before defining the active input region, the active input region has a first location within the input region, and wherein the active-input-region setting indicates the active-input-region location in the input region, wherein the indicated active-input-region location is a second location within the input region, the instructions further comprising:
instructions for, in response to defining the active input region, causing the active input region to move along a touch-input path of a touch-input movement from the first active-input-region location to the second active-input-region location.

35. The non-transitory computer readable medium of claim 30, wherein the user interface further comprises a communication interface configured to communicate with a head-mounted display via a communication network, wherein the active input region is an emulation of a touch-input interface on the head-mounted display.

36. The non-transitory computer readable medium of claim 30, the instructions further comprising:
instructions for determining the active-input-region parameter based on at least one of (i) a user-interface input, (ii) a computing-application event, (iii) a computing-application context, and (iv) an environmental context.

37. The non-transitory computer readable medium of claim 30, wherein the user interface is communicatively coupled to a graphical-display device comprising a graphical display, and wherein the graphical-display device is configured to receive data from at least one of:
(i) a touch-based interface that is integrated with the graphical display;
(ii) a head-mounted device comprising at least one lens element, wherein the graphical display is integrated into the at least one lens element, and a touch-based interface attached to the head-mounted device;
(iii) a gyroscope;
(iv) a thermometer;
(v) an accelerometer; and
(vi) a global-positioning system sensor.

38. The non-transitory computer readable medium of claim 30, wherein the active input region comprises a responsive zone and a non-responsive zone, the instructions further comprising:
instructions for, after defining the active input region, receiving data indicating a touch input within the defined active input region; and
instructions for determining whether the touch input within the defined active input region was within either one of the responsive zone or the non-responsive zone.
